(19) United States
(12) Patent Application Publication
(10) Pub. No.: US 2007/0247512 A1
(43) Pub. Date: Oct. 25, 2007

(54) TRACK CONTROL METHOD FOR MARKING LABEL SIDE OF OPTICAL DISC

(75) Inventors: Jen-Yu Hsu, Hsinchu (TW); Shih-Hung Hsieh, Hsinchu (TW); Yao-Nan Chen, Hsinchu (TW); Ying-Ta Lin, Hsinchu (TW); Yu-Ming Kang, Hsinchu (TW)

Correspondence Address: WPAT, PC, 7225 BEVERLY ST., ANNANDALE, VA, 22003, US

(73) Assignee: LITE-ON IT CORP., Taipei City (TW)

(21) Appl. No.: 11/695,889

(22) Filed: Apr. 3, 2007

(30) Foreign Application Priority Data
Apr. 25, 2006 (TW) 095114627

(51) Int. Cl. B41J 2/435; G01D 15/14

(52) U.S. Cl. 347/224

(57) ABSTRACT

In a track control method for marking a label side of an optical disc, a data side of the optical disc is first oriented to an optical head. A light beam is then emitted and a sled carrying the optical head moves. A series of moving distances of the sled are calculated according to the light beam reflected by the optical disc, which are then recorded in a memory. The optical disc is then flipped to have the label side face the optical head, and the shift of the optical head is controlled to mark on tracks of the label side according to the series of moving distances recorded in the memory.

### FIELD OF THE INVENTION

The present invention relates to a track control method of an optical disc, and more particularly to a track control method for marking the label side of the optical disc.

### BACKGROUND OF THE INVENTION

In the age of multimedia, high volume and high quality video/audio data and game software have become a great part of the market. These data need to be stored in a fast-accessing, low cost and high capacity storage medium, and is preferably able to efficiently make spare copies. Various recordable/rewritable optical discs and corresponding recording apparatus having the feature of making a spare copy of large amount of data in an inexpensive way are thus developed. An optical disc is commonly used for storing large amount of video/audio data, game software, or material and configuration data in professional applications. Therefore, not only has the optical disc recording apparatus become indispensable peripheral equipment for both personal computers and laptops in today's computer industry, in the mainstream digital consumer market, optical disc recording apparatus have begun playing an important role. Users who frequently use the optical disc recording apparatus to create a spare copy of data into a commercial recordable/rewritable optical disc that is pre-designed with monotonous and common label side might suffer from distinguishing these recorded discs.

Conventionally, permanent markers or special pens are used to mark the recorded disc, but human's handwritings are subject to inconvenience or misunderstanding. Printed labels stuck on the non-data face of the recorded disc are another option to specify the information of the disc. The requirements on weight distribution and adhesion of the labels are critical because the uneven weight distribution would adversely affect the rotation of the disc and the fallen-off label could jam the machine.

In light of these issues, a special dye layer that can be burned to form a desired configuration is provided on the label layer of the optical disc. In this way, the label side can be provided with desired marks such as patterns or letters. Marking the label side of an optical disc is generally performed after data is written into the data side of the optical disc. The disc is taken out of the optical disc recorder, flipped to the other side and placed back into the optical disc recorder, and the optical head of the optical disc recorder then projects laser light onto the label side of the optical disc where the special dye is applied to induce a chemical reaction, thereby changing the color of the dye layer and forming a desired pattern on the label side.

Please refer to FIG. 1A which schematically shows the label side of a recordable/rewritable optical disc. The optical disc 110 has radius of 60 mm, and includes a plurality of regions, e.g. a concentric center hole 112 having radius of 7.5 mm and an annular information area 111 lying between radii 22.35 mm and 59 mm. In addition, there is an annular reference region 113 disposed between the center hole 112 and the data area 111 and adjacent to information area 111, as shown in FIG. 1B. The annular reference region 113 is previously provided with a certain pattern and includes an outer ring 124 and an inner ring 126. The outer ring 124 that is not uniformly patterned is recorded with a media ID, a saw tooth and an index mark. The inner ring 126, on the other hand, is provided with a uniform pattern, i.e. alternate “dark” and “bright” spokes, for rotation control while marking the label side. Meanwhile, the saw tooth on the outer ring 124 is used for shift calibration of the optical head, and the media ID and index mark provide other information relating to the optical disc 110.

It is not easy to engrave beautiful pictures or words onto the optical disc. The optical head must accurately control its projection substantially without deviation. As illustrated in FIG. 2A, the optical head 211 of optical disc recording apparatus is carried by a sled 212 that can slide along the radial direction. The function of the sled 212 is to expediently enable long distance displacement of the optical head 211. As depicted in FIG. 2B, there is a range 223 for the optical head 211 to move on the sled 212, and the distance to which the optical head moves can be precisely controlled with a proper control voltage. When no control voltage is applied to the optical head, the optical head will be positioned at the middle position 221 of the sled. Once the optical head is driven with a control voltage, the optical head will produce a shift to another position 224 which is surely within the movable zone 223 of the optical head.

Generally, the sled is transmitted by a rotating lead screw that is driven by a step motor (not shown). However, due to possible machinery imperfection of the step motor and lead screw, it is difficult to precisely control the movement of the sled. Without precise measurement of the sled's movement, balanced and precise marking on the label layer cannot be executed. To further illustrate the point, please see FIG. 2C. When the label side of the optical disc 110 is being marked, the distance between lines is 25 μm, yet the smallest unit distance the sled moves is 100 μm. Thus after at most four lines are marked on the label side, the sled needs to move once. During the period when the sled 212 does not need to move, a proper control voltage is applied to accurately control the shift of the optical head on the sled, thereby creating even spaces between adjacent lines 230, 231, 232 and 233. Then the sled is transmitted by the step motor via the lead screw to move 100 μm to next position so that the optical head may produce another set of four even-spaced lines 234, 235, 236 and 237. In view of the foregoing, if the distance that the sled moves once is not exactly the preset value, e.g. 100 μm, the space between the lines 233 and 234 would deviate from the preset 25 μm. Accordingly, the resulting pattern would become like that shown in FIG. 2D or 2E. When the one-step movement of the step motor exceeds 100 μm, the space between lines 233 and 234 would be like that shown in FIG. 2D. That is, the space between the last line 243 marked before the sled moves and the first line 244 marked after the sled moves would exceed 25 μm. Under this circumstance, relatively light color would be observed through human eyes since the specified space is larger than others. On the other hand, when the one-step movement of the step motor is less than 100 μm, the space between lines 233 and 234 would be like that shown in FIG. 2E. That is, the space between the last line 243 marked before the sled moves and the first line 244 marked after the sled moves would be less than 25 μm. Under this circumstance, relatively dark color would be observed through human eyes since the specified space is smaller than others. As a result, the picture quality of the marked pattern would be unsatisfactory due to uneven color effect.

In order to overcome the above-described problems, an optical ruler (not shown) is disposed in the optical head to assure of accurate movement of the optical head. The optical ruler comprises mainly of a main ruler portion and a secondary ruler portion and is capable of converting an analogous length-indicative signal into a digital signal based on the optical interference principle. The optical ruler is a high-precision device that substantially exempts from interference of electromagnetic signals. Moreover, it is not difficult to maintain the optical ruler as there is no contact or friction between main ruler portion and the secondary ruler portion, and there is generally no need for further calibration of the optical ruler after it is calibrated with a laser interferometer meter before leaving the factory. By using the optical ruler, the inaccurate movement of the sled will not be an issue anymore. However, new issues like cost of the optical ruler and adverse effect in miniaturization would raise.

### SUMMARY OF THE INVENTION

Therefore, the present invention provides a track control method for marking the label side of an optical disc in a precise but cost-efficient way.

The present invention relates to a track control method for marking a label side of an optical disc by an optical disc recording apparatus. The method includes steps of: having a data side of the optical disc face an optical head; emitting a light beam and moving a sled carrying the optical head; calculating a series of moving distances of the sled according to the light beam reflected by the data side of the optical disc, and recording the series of moving distances in a memory; and flipping the optical disc to have the label side face the optical head, and controlling the shift of the optical head for marking on tracks of the label side according to the series of moving distances recorded in the memory.

In an embodiment, each of the series of moving distances is obtained by multiplying the number of sign waves of a tracking error signal by a track pitch.

In another embodiment, each of the series of moving distances is obtained according a difference between address data carried by the reflected light beam before and after the movement of the sled.

In a further embodiment, each of the series of moving distances is obtained according to the control voltages supplied to the optical head before and after the movement of the sled and determined in a track-on control state.

In an embodiment, a plurality of control voltages are applied to move the optical head to a plurality of positions while the sled is fixed at a certain position. Preset values of the control voltages are used for moving the optical head when the moving distance of the sled is equal to a preset distance. However, when the moving distance of the sled is not equal to the preset distance, the preset values of the control voltages are adjusted with a compensation voltage.

Preferably, the moving-distance recording step is executed before sale of the optical disc recording apparatus.

In an embodiment, the reflected light beam is received by a photo-detector to be converted into an electric signal.

In an embodiment, the electric signal is a tracking error signal.

In another embodiment, the electric signal is an address information signal.

The present invention also relates to a track control method for marking a label side of an optical disc, which includes steps of: having a data side of the optical disc face an optical head; moving a sled carrying the optical head; calculating a series of control voltages supplied to the optical head whenever the sled moves, and recording the control voltages in a memory; and flipping the optical disc to have the label side face the optical head, and controlling the shift of the optical head for marking on tracks of the label side according to the series of control voltages recorded in the memory.

### BRIEF DESCRIPTION OF THE DRAWINGS

FIG. 1A is a diagram schematically illustrating a typical optical disc with a markable label side;

FIG. 1B is a diagram schematically illustrating a center portion of an optical disc with a markable label side;

FIG. 2A is a schematic diagrams illustrating the cooperation of a sled and an optical ruler according to prior art;

FIG. 2B is schematic diagram illustrating the shift of the optical head on the sled in response to a control voltage according to prior art;

FIG. 2C is a schematic diagram illustrating the moving distance of a sled and the spaces of lines obtained after the marking operation of the label side of the optical disc;

FIG. 2D is a schematic diagram illustrating the lines resulting from too large moving distance of the sled;

FIG. 2E is a schematic diagram illustrating the lines resulting from too small moving distance of the sled;

FIG. 3A is a schematic diagram illustrating a saw tooth pattern of a markable optical disc provided for calibration;

FIG. 3B is a waveform diagram illustrating two square wave signals with different width generated by the optical head in response to the saw tooth pattern of FIG. 3A;

FIG. 3C is a shift vs. voltage plot varying with the width difference of the square wave signals;

FIG. 4 is a schematic diagram illustrating the relationship among the movement of a sled, the shift of an optical head carried by the sled, and a plurality of lines created by the optical head on the label side of an optical disc;

FIG. 5 is a waveform diagram schematically illustrating the calculation of the moving distance of a sled according to a tracking error signal;

FIG. 6 is a schematic diagram illustrating the calculation of the moving distance of a sled according to the address change before and after the sled moves;

FIG. 7 is a schematic diagram illustrating the calculation of the moving distance of a sled based on close loop control of the optical head; and

FIG. 8 is a schematic diagram illustrating the calculation of control voltages supplied to the optical head based on close loop control of the optical head.

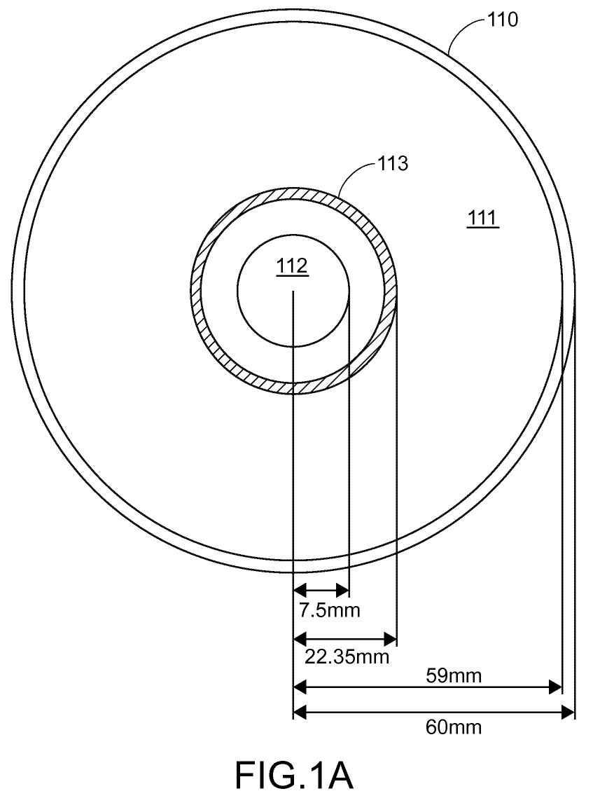

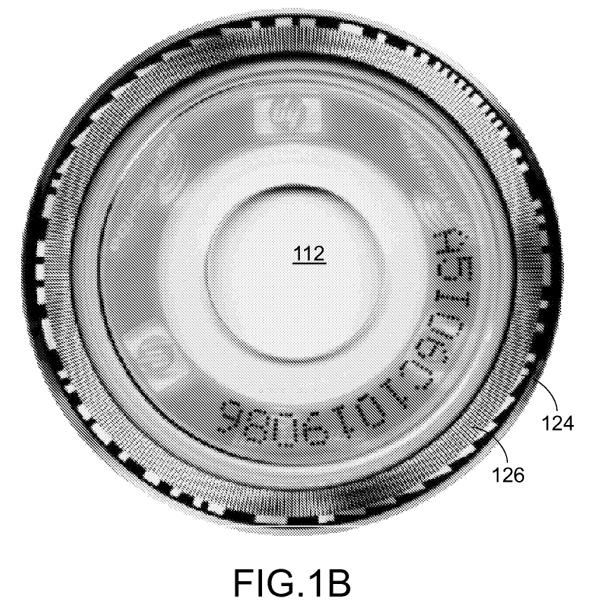

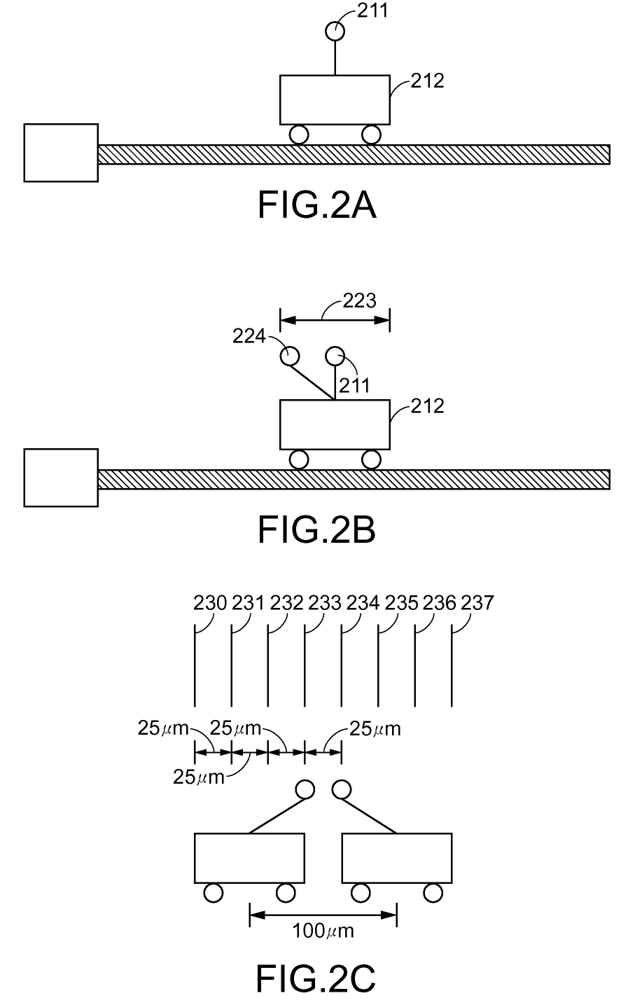

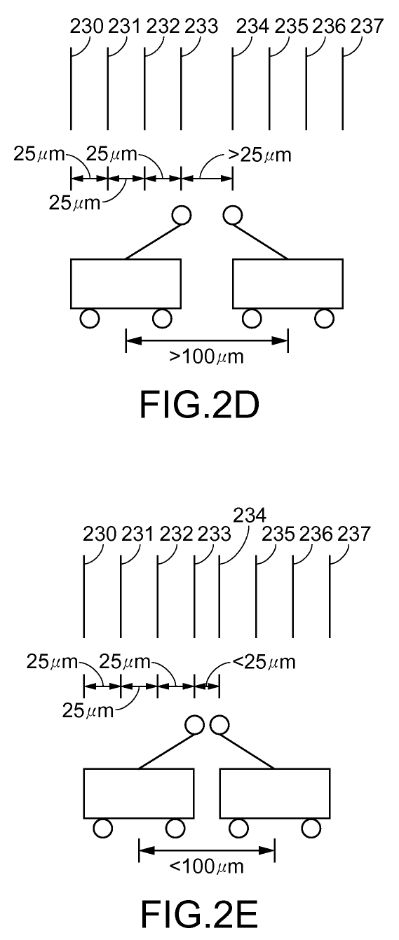

### DETAILED DESCRIPTION OF THE PREFERRED EMBODIMENT

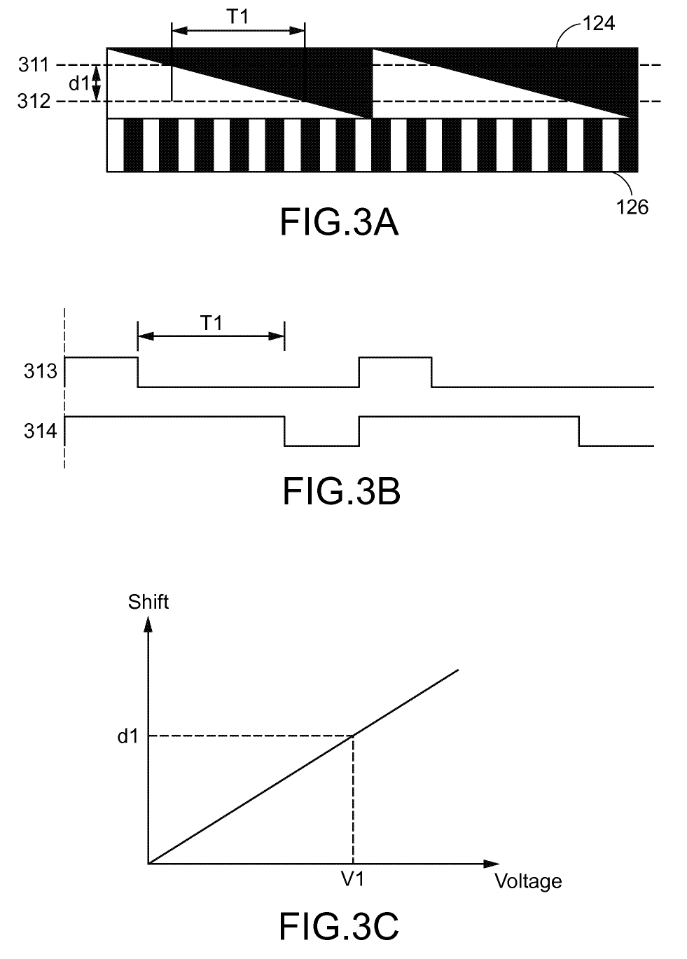

Please refer to FIG. 3A and FIG. 3B, in which the relationship between the shift and the voltage realized by the optical head through the saw tooth pattern is illustrated. When the optical head focuses on the saw tooth, the photo-detector of the optical head generates a square wave signal in response to the bright and dark zones of the saw tooth pattern. As shown in FIG. 3A, on the condition that the sled is not moving, when the control voltage received by optical head is changed so as to move the optical head between the position 311 and the position 312, the width of the square waves generated by the photo-detector varies, as exemplified by the square wave signals 313 and 314 shown in FIG. 3B. According to the width time difference T1 of the square wave signal, a shift d1 of the optical head can be derived. Accordingly, as shown in FIG. 3C, a linear plot of the shift vs. control voltage of the optical head is realized. For example, if a control voltage Δv is needed for 1 μm movement of the optical head outwards along the radial direction, a control voltage −Δv will be needed to move the optical head by 1 μm inwards.

As the distance the sled moves per unit time is not always as precise as expected, the realization of the real moving distance are critical for the shift control of the optical head.

According to an embodiment of the present invention, the moving distances of a sled are tested and recorded in a memory of the optical disc recording apparatus. The recorded distances are then used in the marking operation of the label side of the optical disc together with the voltage control of the optical head for unifying the line space.

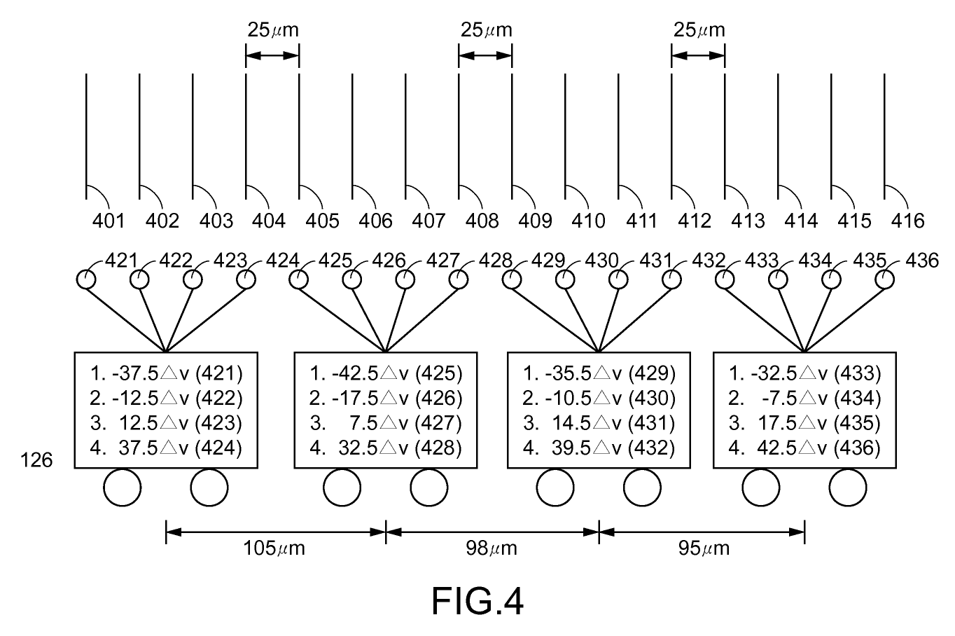

Please refer to FIG. 4, which is a scheme exemplifying the track control for the marking operation of the label side of the optical disc according to an embodiment of the present invention. In this example, the movement of the sled has been tested and a series of moving distances are recorded. For example, the first movement of the sled is 105 μm, the second movement of the sled is 98 μm, and the third movement of the sled is 95 μm.

When the moving distance of the sled is ideally 100 μm, the control voltages supplied to the optical head for marking four lines 401˜404 on the first to fourth tracks are −37.5 Δv, −12.5 Δv, 12.5 Δv and 37.5 Δv, respectively. In response, the optical head is capable of shifting to the positions 421˜424 to accomplish the even line space 25 μm. However, when the moving distance of the sled is 105 μm, which means the sled has moved 5 μm more outwards than the ideal 100 μm. Accordingly, the optical head needs to further move 5 μm inward to mark four lines 405˜408 on the fifth to eighth tracks. That is, the optical head is supplied with control voltages of −42.5 Δv, −17.5 Δv, 17.5 Δv and 32.5 Δv to shift to the positions 425˜428, thereby achieving the purpose of unifying the line space. Likewise, when the sled makes the second movement of 98 μm, which means the sled has moved 2 μm less outwards than the ideal 100 μm. Accordingly, the optical head needs to further move 2 μm outward to mark four lines 409˜412 on the ninth to twelfth tracks. That is, the optical head is supplied with control voltages of −35.5 Δv, −10.5 Δv, 14.5 Δv and 39.5 Δv to shift to the positions 429˜432, thereby achieving the purpose of unifying the line space. Moreover, when the sled makes the third movement of 95 μm, which means the sled has moved 5 μm less outwards than the ideal 100 μm. Accordingly, the optical head needs to further move 5 μm outward to mark four lines 413˜416 on the thirteenth to sixteenth tracks. That is, the optical head is supplied with control voltages of −32.5 Δv, −7.5 Δv, 17.5 Δv and 42.5 Δv to shift to the positions 433˜436, thereby achieving the purpose of unifying the line space. Subsequent tracks are processed in a similar way.

Accordingly, by testing each moving distance of the sled and recording the result in the memory of the optical disc recording apparatus, together with the voltage control of the optical head, the space of lines resulting in the marking operation of the label side of the optical disc can be unified.

The determination and recordation of moving distances of a sled can be performed before the sale of the optical disc recording apparatus. In principle, a light beam emitted by the optical head is focused on the optical disc, and the reflected light is detected by a photo-detector. The photo-detector then outputs an electric signal according to the intensity of the reflected light. The electric signal generally includes a data signal and a control signal. The data signal includes not only the data to be recorded into the optical disc but also the address information provided for position identification. The address information will be referred for determining the moving distances of the sled. The control signal includes a focusing error signal and a tracking error signal. In an embodiment, the tracking error signal is referred to for determining the moving distances of the sled.

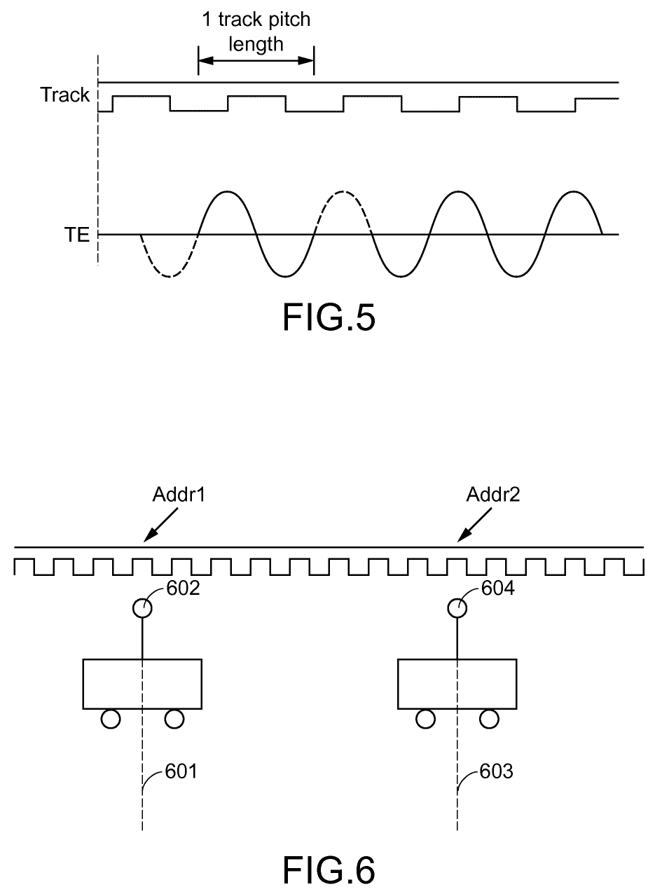

For example, an open-loop (track-off) control mechanism of the optical head is applied. As depicted in FIG. 5, whenever the optical head under open-loop control crosses a track, the tracking error signal generates a sign wave. Therefore, by placing a common optical disc into the optical disc drive and having the data side of optical disc face the optical head, the moving distance of the sled can be obtained by multiplying the number of sign waves generated during the movement of the sled by the track pitch, e.g. 0.74 μm for DVD and 1.6 μm for CD. In this way, a series of moving distances of the sled can be determined and recorded in the memory.

Alternatively, the address information of the tracks is accessed by the optical head to calculate the moving distance of the sled. The address information is used for effectively correlating the data recorded in the optical disc to the recording positions. For example, for DVD, exclusive address information is given for every 2048 bytes of data. The address information is recorded in the identification data region (ID data region) of a data frame. The address information can be accessed from this region. For Blu-Ray Disc, every 2048 bytes of data is grouped as a data sector, and each data sector corresponds to exclusive address information. Such address information may have various types, including a physical sector number. The address information is recorded in a data frame along with common data. Therefore, after reading data from the data frame, a decoding procedure is required to extract the physical sector number, i.e. the address information of a Blu-Ray disc. In brief, for different disc specifications, different types of address information will be exhibited. The address information is recorded as different specifications and/or in different regions. Nevertheless, other address information involving correlation of the data to the recording positions can be used to calculate the moving distance of the sled. The operational principle of this embodiment will be described in more detail with reference to FIG. 6.

First of all, a common optical disc is inserted into the optical disc drive with the data side of optical disc facing the optical head. When the sled is to be moved from the position 601, the optical head at the position 602 is made in a closed-loop (track-on) control state in advance. Meanwhile, the optical head reads a first data address Addr1 of a corresponding track. Then, the optical head is switched into an open-loop (track-off) control state and the sled is moved. After the sled finishes moving, the optical head is switched into the closed-loop (track-on) control state again. Meanwhile, the optical head reads a second data address Addr2 of a corresponding track. According to the address difference between the second data address and the first data address, the moving distance of the sled can be realized. In this way, a series of moving distances of the sled can be determined and recorded in the memory.

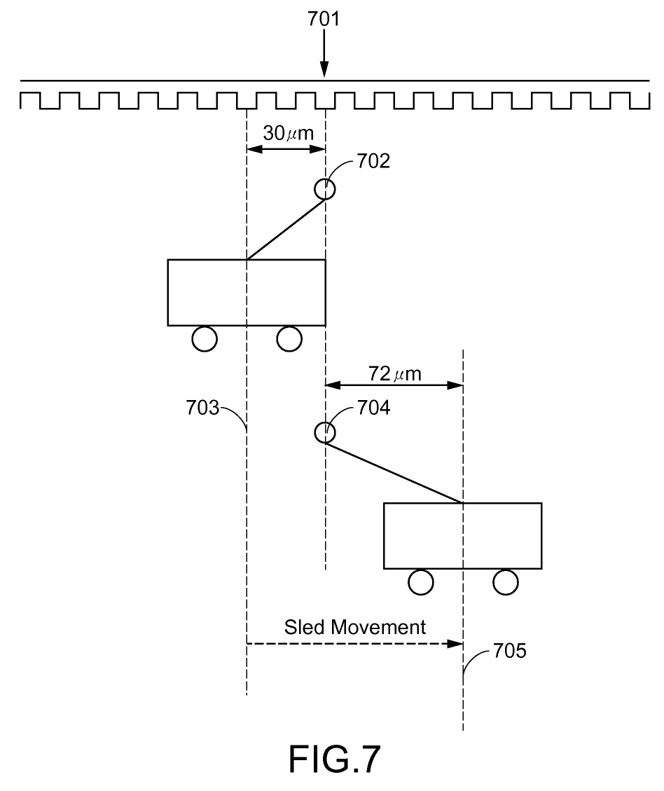

In a further embodiment, a closed-loop (track-on) control mechanism of the optical head is applied. Please refer to FIG. 7. First of all, a common optical disc is inserted into the optical disc drive with the data side of optical disc facing the optical head. Before the sled is moved from the position 703, the optical head at the position 702 is made in a closed-loop (track-on) control state in advance. Meanwhile, the optical head locks the track 701, and then shifts to the position 702. The optical disc drive records a first control voltage required for shifting the optical head to the position 702, e.g. 30 Δv that means the optical head shifts 30 μm rightward, as shown in the figure. Then, the sled is moved while the optical head remains in the closed-loop (track-on) control state. After the sled finishes moving to the position 705 (meanwhile the optical head is at the position 704), a second control voltage supplied to the optical head is recorded, e.g. −72 Δv that means the optical head shifts 72 μm leftward, as shown in the figure. According to the difference between the first control voltage and the second control voltage, it is understood that the moving distance of the sled is 102 μm. In this way, a series of moving distances of the sled can be determined and recorded in the memory.

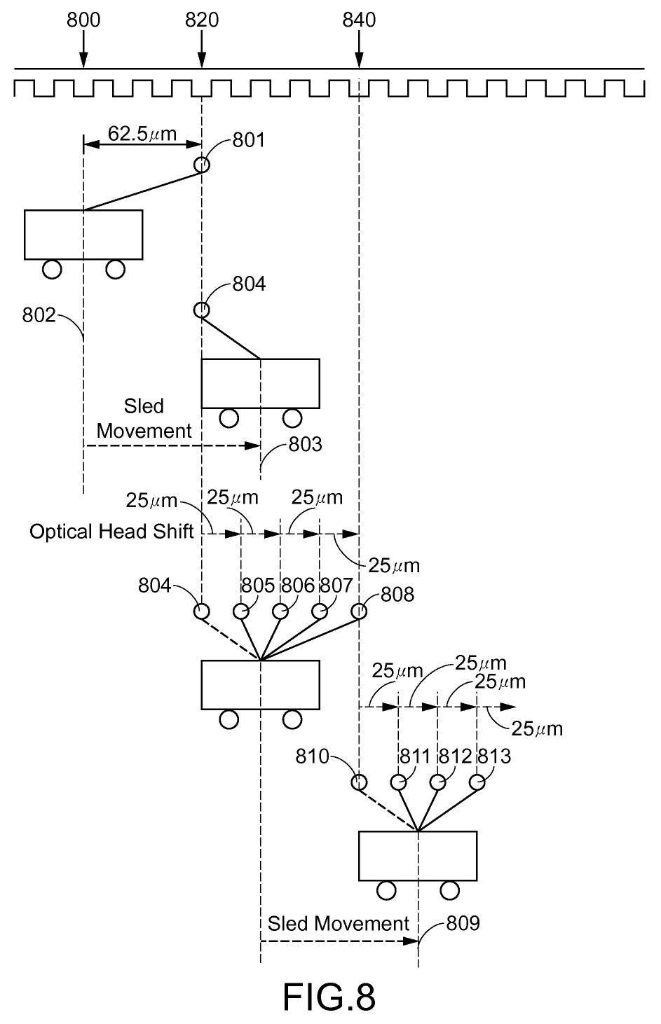

In addition to calculating and storing the moving distances of the sled, other embodiments of the present invention can be implemented by storing the control voltages of the optical head. Please refer to FIG. 8. First of all, a common optical disc is inserted into the optical disc drive with the data side of optical disc facing the optical head. Meanwhile, the sled is at the position 802 and the center of the sled is aligned with a certain track, e.g. track 800. After shifting the optical head by a distance of 62.5 μm to reach the position 801, the optical head is controlled in a closed-loop (track-on) control state. Meanwhile, the optical head is locking a certain track, e.g. track 820. Afterwards, the sled is moved to the position 803 while the optical head shifts to the position 804 to continue locking the track 820. The control voltage v1 required for shifting the optical head to the position 804 is recorded in the memory. Afterwards, the optical head is shifted from the position 804 to the position 805, the position 806 and the position 807 that are 25 μm, 50 μm and 75 μm from the position 804, respectively. The control voltages v2, v3 and v4 required for these shifts are also recorded into the memory. Subsequently, the optical head is shifted to the position 808 that is 25 μm from the position 807. The track, e.g. track 804, being locked by the optical head at the position 808 is recorded. The sled is then moved to the position 809 while the optical head remains locking the track 840. The control voltage v5 required for shifting the optical head to the position 810 is recorded in the memory. Afterwards, the optical head is shifted from the position 810 to the position 811, the position 812 and the position 813 that are 25 μm, 50 μm and 75 μm from the position 804, respectively. The control voltages v6, v7 and v8 required for these shifts are also recorded into the memory. Likewise, subsequent control voltages supplied to the optical head are recorded. Whenever the sled makes a movement, there will be four control voltages needed recording. After the sled finishes the movements, the control voltages of all positions of the optical head are recorded. According to these control voltages recoded in the memory, the optical head can be well controlled and moved to the desired track precisely for marking the label side of the optical disc.

According to the present invention, the movement of the sled is accurately measured in a cost-effective manner so as to improve color effect.

The present invention is intended to cover various modifications and similar arrangements included to within the spirit and scope of the appended claims, which are to be accorded with the broadest interpretation so as to encompass all such modifications and similar structures.

What is claimed is:

1. A track control method for marking a label side of an optical disc by an optical disc recording apparatus, comprising steps of:
having a data side of the optical disc face an optical head;
emitting a light beam and moving a sled carrying the optical head;
calculating a series of moving distances of the sled according to the light beam reflected by the data side of the optical disc, and recording the series of moving distances in a memory; and
flipping the optical disc to have the label side face the optical head, and controlling the shift of the optical head for marking on tracks of the label side according to the series of moving distances recorded in the memory.

2. The method according to claim 1 wherein each of the series of moving distances is obtained by multiplying the number of sign waves of a tracking error signal by a track pitch.

3. The method according to claim 1 wherein each of the series of moving distances is obtained according a difference between address data carried by the reflected light beam before and after the movement of the sled.

4. The method according to claim 1 wherein each of the series of moving distances is obtained according to the control voltages supplied to the optical head before and after the movement of the sled and determined in a track-on control state.

5. The method according to claim 1 wherein a plurality of control voltages are applied to move the optical head to a plurality of positions, respectively, when the sled is fixed at a certain position.

6. The method according to claim 5 wherein preset values of the control voltages are used for moving the optical head when the moving distance of the sled is equal to a preset distance.

7. The method according to claim 6 wherein the preset values of the control voltages are adjusted with a compensation voltage when the moving distance of the sled is not equal to the preset distance.

8. The method according to claim 1 wherein the moving-distance recording step is executed before sale of the optical disc recording apparatus.

9. The method according to claim 1 wherein the reflected light beam is received by a photo-detector to be converted into an electric signal.

10. The method according to claim 9 wherein the electric signal is a tracking error signal.

11. The method according to claim 9 wherein the electric signal is an address information signal.

12. A track control method for marking a label side of an optical disc, comprising steps of:
having a data side of the optical disc face an optical head;
moving a sled carrying the optical head;
calculating a series of control voltages supplied to the optical head whenever the sled moves, and recording the control voltages in a memory; and
flipping the optical disc to have the label side face the optical head, and controlling the shift of the optical head for marking on tracks of the label side according to the series of control voltages recorded in the memory.
